(19) United States
(12) Patent Application Publication
(10) Pub. No.: US 2004/0003774 A1
(43) Pub. Date: Jan. 8, 2004

(54) Continuous galvanizing system

(76) Inventor: B. L. Moore, Madill, OK (US)

Correspondence Address: B.L. Moore, Highway 70 South, P O Box 220, Madill, OK, 73446, US

(21) Appl. No.: 10/190,290

(22) Filed: Jul. 3, 2002

(51) Int. Cl. B05C 3/12

(52) U.S. Cl. 118/420; 118/423

(57) ABSTRACT

A continuous galvanizing system includes a feed system for providing a continuous supply of material to be galvanized. A furnace receives the material from the feed system for heating the material. A continuous flux line applies liquid flux to the heated material at an exit end of the furnace prior to exposing the material to atmosphere. A zinc furnace galvanizes the heated material.

### FIELD OF THE INVENTION

This invention relates to a galvanizing system and, more particularly, a continuous galvanizing system that applies liquid flux to a heated material prior to galvanizing.

### BACKGROUND OF THE INVENTION

Galvanizing is a process used for coating a metal, such as iron or steel, with zinc. The zinc protects the metal from corrosion. A galvanized metal is typically prepared by removing rust using sulfuric acid or the like and then dipping the metal into molten zinc. A layer of the zinc remains on the surface of the metal.

Continuous galvanizing systems are used for galvanizing metal products such as wire, fencing, sheeting and tubing. One known galvanizing system runs the material through a cleaner, such as a sand furnace, and subsequently through an anneal furnace. Thereafter, the material is submerged in hydrochloric acid and air dried. A galvanizing flux may be used to dissolve any oxides that form on the metal and prevent further oxidation before galvanizing. The material is then run through a galvanizing kettle or zinc furnace, or the like, including a molten bath of zinc. A zinc alloy is formed on the material when the material reaches the temperature of the bath, which is typically on the order of 850° F. The longer the material is submerged, the heavier the coating. With continuous systems it is desirable to run the material through at high speeds. However, due to the time required to elevate temperature of the material, the line speeds may only be on the order of 100 feet per minute. This must be done to ensure that the finished product maintains appropriate ratings and classification for desired uses. For example, a class 1 coating of about 0.28 inches cannot be achieved at higher speeds.

The present invention is directed to overcoming one or more of the problems discussed above in a novel and simple manner.

### SUMMARY OF THE INVENTION

In accordance with the invention, there is provided a continuous galvanizing system which applies liquid flux to a heated material at an exit end of a furnace prior to exposing the material to atmosphere.

Broadly, a continuous galvanizing system in accordance with the invention includes feed means for providing a continuous supply of material to be galvanized. A furnace receives the material from the feed means for heating the material. Means are provided for applying liquid flux to the heated material at an exit end of the furnace prior to exposing the material to atmosphere. A zinc furnace galvanizes the heated material.

It is a feature of the invention that the furnace comprises a tube furnace and the material passes through a tube in the furnace. The tube may be filled with hydrogen. The applying means may deliver a continuous supply of the liquid flux at an exit end of the tube. The tube may be tilted downwardly whereby the liquid flux seals the exit end of the tube.

It is another feature of the invention that the furnace heats the material to a temperature of above 1000° F. and the liquid flux bakes on the material and cools the material to less than a temperature of the zinc furnace.

There is disclosed in accordance with another aspect of the invention a continuous wire galvanizing system including a feed system for providing a continuous supply of wire between a supply frame and a take-up frame. A tube furnace has a tube receiving the wire from the supply frame for heating the wire. Means are provided for supplying liquid flux at an exit end of the tube to submerge the wire prior to exposing the wire to atmosphere. A zinc furnace galvanizes the heated wire.

The tube furnace may heat the wire to a temperature of over 1,000° F. and the liquid flux bakes on the wire and cools the wire to a temperature less than a temperature of the zinc furnace. The zinc furnace may have a temperature of about 850° F.

It is a feature of the invention that the feed system feeds the wire at a speed greater than about 200 feet per minute. The speed may be in the range of about 200-250 feet per minute.

There is disclosed in accordance with another aspect of the invention a continuous wire galvanizing system comprising a feed system for providing a continuous supply of wire between a supply frame and take-up frame. A first furnace preheats the wire from the supply frame. A second furnace receives the preheated wire for annealing the wire in a hydrogen atmosphere. Means are provided for recirculating liquid flux at an exit end of the second furnace to submerge the wire prior to exposing the wire to ambient atmosphere. A zinc furnace galvanizes the annealed wire.

Further features and advantages of the invention will be readily apparent from the specification and from the drawings.

### BRIEF DESCRIPTION OF THE DRAWINGS

FIG. 1 is a schematic view of a continuous wire galvanizing system in accordance with the invention; and

FIG. 2 is a detailed side view illustrating the system for applying liquid flux to the heated wire in the galvanizing system of FIG. 1.

### DETAILED DESCRIPTION OF THE INVENTION

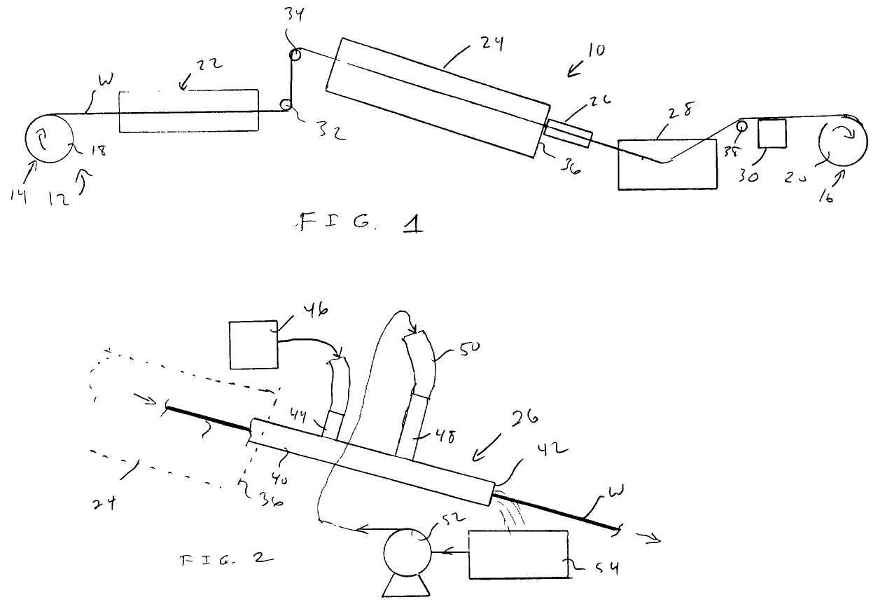

Referring to the drawings, and particularly initially to FIG. 1, a continuous galvanizing system 10 in accordance with the invention is illustrated. The continuous galvanizing system 10 implements a process for coating a metal, such as iron or steel, with zinc. In the illustrated embodiment of the invention, the continuous galvanizing system 10 comprises a wire galvanizing system. However, the continuous galvanizing system 10 could be used for galvanizing other materials such as, for example, fencing, sheet and tubing material.

The galvanizing system 10 includes a feed system 12 for providing a continuous supply of wire W between a supply frame 14 and a take-up frame 16. The supply frame 14 is illustrated schematically as a spool 18 driven in a direction indicated by an arrow. The take-up frame 16 is illustrated schematically by a spool 20 driven in a rotation indicated by an arrow. The spools 18 and 20 are driven by conventional external apparatus (not shown) to feed a wire W therebetween. As will be apparent other any drive system may be used to provide a continuous supply of wire W for the described galvanizing process.

Particularly, the galvanizing system 10 further comprises a sand furnace 22, a tube furnace 24, a flux line 26, a zinc furnace 28 and a wax line 30. The wire W from the supply frame spool 18 is initially fed through the sand furnace 22, upwardly around a first roller 32, and then over a second roller 34 and subsequently through the tube furnace 24. The flux line 26 is positioned at an exit end 36 of the tube furnace 24. The wire W passes from the flux line 26 to the zinc furnace 28. The wire then passes over a third roller 38, over the wax line 30 and then is taken up on the take-up frame spool 20.

The sand furnace 22 is conventional in nature and may comprise a forty foot long sand furnace including a fluid fire at approximately 1,400° F. Particularly, such a conventional sand furnace 22 may conclude aluminum oxide through which the wire W passes with air underneath to heat the wire to a red hot condition for cleaning the wire W.

The tube furnace 24 is generally conventional in construction. In the illustrated embodiment of the invention, the tube furnace 24 is approximately sixty feet long and includes twenty four one inch stainless steel tubes. Referring to FIG. 2, a portion of one of the twenty four tubes 40 is illustrated. The tube 40 extends past the furnace exit end 36, illustrated in phantom in FIG. 2, and is used in the flux line 26, as described below. The wire W passes through the tube 40. As a result the continuous galvanizing system 10 can galvanize up to 24 lines of wire simultaneously. Because the process for each line is the same only one is described in detail herein. The tubes are surrounded by hot electrodes (not shown) with a water jacket around the tubes. The tube furnace 24 may be set to a temperature on the order of 1,600° F. In an exemplary embodiment of the invention, the wire W exits the annealing tube furnace at a temperature above 1,000° F.

The tube 40 is tilted at about a 15° angle to a horizontal plane. The tube 40 has an exit end 42 through which the wire is withdrawn. A first “T” 44 is provided generally proximate the exit end 42 for introducing hydrogen from a hydrogen source 46. A second “T” 48 is disposed between the first “T” 44 and the exit end 42. A hose 50 is connected between the second “T” 48 and a pump 52. The pump 52 has an inlet connected to a vessel 54. The vessel 54 stores a supply of liquid flux. The liquid flux may be, for example, zinc aluminum chloride and water. Other flux materials can be used. The second “T” 48 acts as a manifold for the liquid flux. The pump 52 pumps the liquid flux via the second “T” 48 into the tube 40 proximate the exit end 42 to submerge the wire W. The flux bakes on the annealed wire. Because of the tilt of the tube 40, excess liquid flux is always in the tube 40 at the exit end 42 and drains to the vessel 54. The liquid flux as such makes an airtight seal to keep the hydrogen atmosphere inside the tube 40 so the heated wire is sealed from the ambient atmosphere. The wire W is then exposed to ambient atmosphere after exiting the tube exit end 42 but the wire W is prevented from oxidizing by the baked on flux.

The zinc furnace 28 comprises about a thirty foot bath of zinc and has a galvanizing bath temperature of about 850° F. The flux line 26 cools the wire approximately 200° so that it is below the 850° F. temperature of the zinc furnace 28. This allows the wire W to heat back up to the galvanizing bath temperature.

As described, the flux agent being applied to the heated annealed wire W bakes on very rapidly and provides a brighter, smoother and more consistent wire product. More particularly, in an exemplary embodiment to the invention, the tube furnace 24 heats the wire to about 1,000° and is operated at above 200 feet per minute and, particularly, at a range of about 200-250 feet per minute. Because of the tilt angle of the tube 40 excess liquid flux is always in the tube 40 to seal the tube end 42. This satisfies two purposes. One, the liquid flux cools the wire a few degrees below the temperature of the zinc furnace 28 which is necessary for good galvanizing and does so at high speed. Additionally, there is no acid bath used anywhere or rinse water that is acid rich.

Thus, in accordance with the invention, the continuous galvanizing system includes the ability to apply a controlled flux on the wire while operating the system at a high speed.

I claim:

1. A continuous galvanizing system comprising:
feed means for providing a continuous supply of material to be galvanized;
a furnace receiving the material from the feed means for heating the material;
means for applying liquid flux to the heated material at an exit end of the furnace prior to exposing the material to atmosphere; and
a zinc furnace for galvanizing the heated material.

2. The continuous galvanizing system of claim 1 wherein the furnace comprises a tube furnace and the material passes through a tube in the furnace.

3. The continuous galvanizing system of claim 2 wherein the tube is filled with hydrogen.

4. The continuous galvanizing system of claim 2 wherein the applying means delivers a continuous supply of the liquid flux at an exit end of the tube.

5. The continuous galvanizing system of claim 4 wherein the tube is tilted downwardly whereby the liquid flux seals the exit end of the tube.

6. The continuous galvanizing system of claim 1 wherein the furnace heats the material to a temperature above 1000 degrees F. and the liquid flux bakes on the material and cools the material to a temperature less than a temperature of the zinc furnace.

7. A continuous wire galvanizing system comprising:
a feed system for providing a continuous supply of wire between a supply frame and a takeup frame;
a tube furnace having a tube receiving the wire from the supply frame for heating the wire;
means for supplying liquid flux at an exit end of the tube to submerge the wire prior to exposing the wire to atmosphere; and
a zinc furnace for galvanizing the heated wire.

8. The continuous wire galvanizing system of claim 7 wherein the tube is filled with hydrogen.

9. The continuous wire galvanizing system of claim 8 wherein the tube is tilted downwardly whereby the liquid flux seals the exit end of the tube.

10. The continuous wire galvanizing system of claim 7 wherein the tube furnace heats the wire to a temperature above 1000 degrees F. and the liquid flux bakes on the wire and cools the wire to a temperature less than a temperature of the zinc furnace.

11. The continuous wire galvanizing system of claim 10 wherein the zinc furnace has a temperature of about 850 degrees F.

12. The continuous wire galvanizing system of claim 7 wherein the feed system feeds the wire at a speed greater than about 200 feet per minute.

13. The continuous wire galvanizing system of claim 7 wherein the feed system feeds the wire at a speed in a range of about 200 to 250 feet per minute.

14. A continuous wire galvanizing system comprising:
a feed system for providing a continuous supply of wire between a supply frame and a take-up frame;
a first furnace for pre-heating the wire from the supply frame;
a second furnace receiving the pre-heated wire for annealing the wire in a hydrogen atmosphere;
means for recirculating liquid flux at an exit end of the second furnace to submerge the wire prior to exposing the wire to ambient atmosphere; and
a zinc furnace for galvanizing the annealed wire.

15. The continuous wire galvanizing system of claim 14 wherein the second furnace comprises a tube furnace and the wire passes through a tube in the furnace.

16. The continuous wire galvanizing system of claim 15 wherein the tube is filled with hydrogen.

17. The continuous wire galvanizing system of claim 15 wherein the tube is tilted downwardly whereby the liquid flux seals the exit end of the tube.

18. The continuous wire galvanizing system of claim 14 wherein the second furnace heats the wire to a temperature above 1000 degrees F. and the liquid flux bakes on the wire and cools the wire to a temperature less than a temperature of the zinc furnace.

19. The continuous wire galvanizing system of claim 18 wherein the zinc furnace has a temperature of about 850 degrees F.

20. The continuous wire galvanizing system of claim 14 wherein the feed system feeds the wire at a speed greater than about 200 feet per minute.

21. The continuous wire galvanizing system of claim 14 wherein the feed system feeds the wire at a speed in a range of about 200 to 250 feet per minute.
